(19) United States
(12) Patent Application Publication
(10) Pub. No.: US 2015/0139746 A1
(43) Pub. Date: May 21, 2015

(54) Latch Assembly

(71) Applicants: Scott A. Britson, Garner, IA (US); Matthew W. Schroeder, Ventura, IA (US); Mitchell P. Horstman, Garner, IA (US)

(72) Inventors: Scott A. Britson, Garner, IA (US); Matthew W. Schroeder, Ventura, IA (US); Mitchell P. Horstman, Garner, IA (US)

(21) Appl. No.: 14/081,633

(22) Filed: Nov. 15, 2013

(51) Int. Cl. B60P 7/13; F16F 1/18

(52) U.S. Cl. CPC B60P 7/13; F16F 1/18
USPC 410/77; 267/164; 403/326

(57) ABSTRACT

In accordance with example embodiments, a system may include a first frame pivotally mounted on a second frame and a latch attached to the first frame. In example embodiments, the latch may include a latch arm pivotally connected to the first frame and a spring attached to the latch arm. In example embodiments the spring may include a wheel configured to engage the second frame so that when the wheel is engaged with the second frame, at least a portion of the latch arm is rotated above an upper surface of the first structure and when the wheel is not engaged with the second frame the latch arm is substantially, if not entirely, below the upper surface of the first structure.

### BACKGROUND

1. Field

Example embodiments relate to a latch assembly. In example embodiments the latch assembly may be used to for multiple purposes including, but not limited to, securing a container to a roll-on truck.

2. Description of the Related Art

Roll-on containers are relatively large structures usable for storing large quantities of materials. In general, roll-on containers include wheels or rollers that allow the container to be loaded and unloaded from a roll on roll off truck.

FIG. 8A illustrates a roll-on truck 2000 arranged near a roll-on container 3000. The roll-on truck 2000 includes a tilt frame 2200 pivotally attached to a chassis 2100 of the roll-on truck 2000. As shown in at least FIG. 8C, the tilt frame 2200 may be rotated under the influence of a hydraulic cylinder 2400 which may be supported by the chassis 2100. The roll-on truck 2000 also generally includes a reeving mechanism 2300, or alternatively, a winch, which may be used to pull the container 3000 onto the roll-on truck 2000.

Referring to FIGS. 8A-8F, the container 3000 may be loaded onto the roll-on truck 2000 by executing the following steps. First, the roll-on truck 2000 may be arranged adjacent the container 3000 as shown in FIG. 8A. Next, a cable 2350 of the reeving mechanism 2300 may be attached to the container 3000 as shown in FIG. 8B. Then, as shown in FIG. 8C, the tilt frame 2200 may be rotated by the hydraulic cylinder 2400. After the tilt frame 2200 is rotated, the reeving mechanism 2300 may be activated to pull the container 3000 onto the tilt frame 2200 as shown in FIGS. 8C to 8E. After the container 3000 is loaded onto the tilt frame 2200, the tilt frame 2200 may be rotated back to a relatively horizontal position as shown in FIG. 8F. In this configuration, the reeving mechanism 2300 may pull the container to a latching mechanism which may be a part of the tilt frame 2200.

FIG. 9 is a view of a spring 2210 used with a conventional latching system of a conventional roll-on truck 2000. As shown in FIG. 9, the spring 2210 may include a first end 2230 having a hole 2235 therein and a curved second end 2240. In the conventional art, the conventional spring 2210 may be attached to a latch arm 2250 as shown in at least FIGS. 10A-10B. As shown in FIGS. 10A-10B, the latch arm 2250 may be pivotally attached to the tilt frame 2200 by a pin 2255. FIG. 10B illustrates the second end 2240 of the spring 2210 contacting the chassis 2100 of the roll-on truck 2000. In the conventional art, contact occurs when the tilt frame 2200 lies on or becomes very close to a top of the chassis 2100. However, when the tilt frame 2200 is rotated away from the chassis 2100, as shown in FIG. 10A, the second end 2240 of the spring 2210 may no longer contact the chassis 2100.

FIGS. 11A-11C illustrate a conventional latching system of a conventional roll-on truck 2000. As shown in FIG. 11A, the latching system may include the latch arm 2250 and the spring 2210. Also shown in FIG. 11A is a close up view of the container 3000 with an emphasis on a wheel 3050 of the container 3000 rolling along the tilt frame 2200. As shown in FIGS. 11A-11C, the container 3000 may roll along the tilt frame 2200 until the wheel 3050 contacts the latch arm 2250. The contact, as shown in FIG. 11B causes the latch arm 2250 to rotate downwards until the wheel 3050 passes completely over the latch arm 2250 in which case the latch arm 2250, under the influence of the spring 2210, is rotated back to its previous position as shown in FIG. 11C. After the latch arm 2250 has rotated back to its previous position, the wheel 3050 of the container 3000 is captured between the latch arm 2250 and a stop 2275 of the tilt frame 2200. In this manner the container 3000 is latched onto the tilt frame 2200 of the roll-on truck 2000.

### SUMMARY

Applicants note latching systems associated with roll-on trucks are susceptible to failure after repeated use. For example, the prior art spring 2210 of the aforementioned latching system often breaks after only a few uses. Applicants know of no suitable replacements available in the market. Accordingly, Applicants set out to design a new latching system which is superior to the latching systems available in the marketplace. As a result, Applicants developed a new, useful, and nonobvious latching system usable to secure roll-on containers to roll-on trucks. However, Applicants note their latching system may be used in other systems other than that associated with a roll-on truck. For example, the latching system may be used in the boating industry to secure a boat to a trailer. Also, the latching system itself includes new and novel features. Thus, the invention should not be limited to merely a latching system.

Example embodiments relate to a latch assembly. In example embodiments the latch assembly may be used for multiple purposes including, but not limited to, securing a container to a roll-on truck.

In accordance with example embodiments, a spring assembly may include a spring and a wheel assembly. In example embodiments the spring may have a first interfacing region, a second interfacing region, and a connecting region between the first interfacing region and the second interfacing region. In example embodiments the connecting region may provide resilience to the spring. Also, in example embodiments, the wheel assembly may be attached to the second interfacing region.

In accordance with example embodiments, a latch may include a spring assembly and a latch arm attached to a first interfacing region of the spring assembly.

In accordance with example embodiments, a structure may include a primary support member and a latch having a latch arm pivotally attached to the primary support member.

In accordance with example embodiments, a system may include a structure and an engaging member, wherein a wheel of a latch system associated with the structure may be configured to engage the engaging member.

In accordance with example embodiments, a system may include a first frame pivotally mounted on a second frame and a latch attached to the first frame. In example embodiments, the latch may include a latch arm pivotally connected to the first frame and a spring attached to the latch arm. In example embodiments the spring may include a wheel configured to engage the second frame so that when the wheel is engaged with the second frame, at least a portion of the latch arm is rotated above an upper surface of the first frame and when the wheel is not engaged with the second frame the latch arm is below the upper surface of the first frame.

### BRIEF DESCRIPTION OF THE DRAWINGS

Example embodiments are described in detail below with reference to the attached drawing figures, wherein:

FIGS. 1A-1C are views of a spring assembly in accordance with example embodiments;

FIGS. 2A and 2B are views of spring assemblies in accordance with example embodiments;

FIG. 3A and 3B are views of a spring assembly attached to a latch arm in accordance with example embodiments;

FIGS. 4A-4B are views of a latching system in accordance with example embodiments;

FIGS. 5A-5B are views of the latching system incorporated into a structure in accordance with example embodiments;

FIGS. 6A-6B are views of the latching system incorporated into a structure in accordance with example embodiments;

FIGS. 7A-7D are views of the latching system in accordance with example embodiments;

FIGS. 8A-8F are views of a container being rolled onto a roll-on truck in accordance with the conventional art;

FIG. 9 illustrates an example of a spring in accordance with the conventional art;

FIGS. 10A-10B illustrate the spring in accordance with the conventional art secured to a latch arm in accordance with the conventional art; and

FIGS. 11A-11C illustrate a conventional latch system in accordance with the conventional art.

### DETAILED DESCRIPTION

Example embodiments will now be described more fully with reference to the accompanying drawings, in which example embodiments of the invention are shown. The invention may, however, be embodied in different forms and should not be construed as limited to the example embodiments set forth herein. Rather, these example embodiments are provided so that this disclosure will be thorough and complete, and will fully convey the scope of the invention to those skilled in the art. In the drawings, the sizes of components may be exaggerated for clarity.

In this application, it is understood that when an element or layer is referred to as being “on,” “attached to,” “connected to,” or “coupled to” another element or layer, it can be directly on, directly attached to, directly connected to, or directly coupled to the other element or layer or intervening elements that may be present. In contrast, when an element is referred to as being “directly on,” “directly attached to,” “directly connected to,” or “directly coupled to” another element, there are no intervening elements present. As used herein, the term “and/or” includes any and all combinations of one or more of the associated listed items.

In this application it is understood that, although the terms first, second, etc. may be used herein to describe various elements and/or components, these elements and/or components should not be limited by these terms. These terms are only used to distinguish one element, component, region, layer, and/or section from another elements, component, region, layer, and/or section. Thus, a first element, component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to planform views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a latch assembly. In example embodiments the latch assembly may be used to for multiple purposes including, but not limited to, securing a container to a roll-on truck.

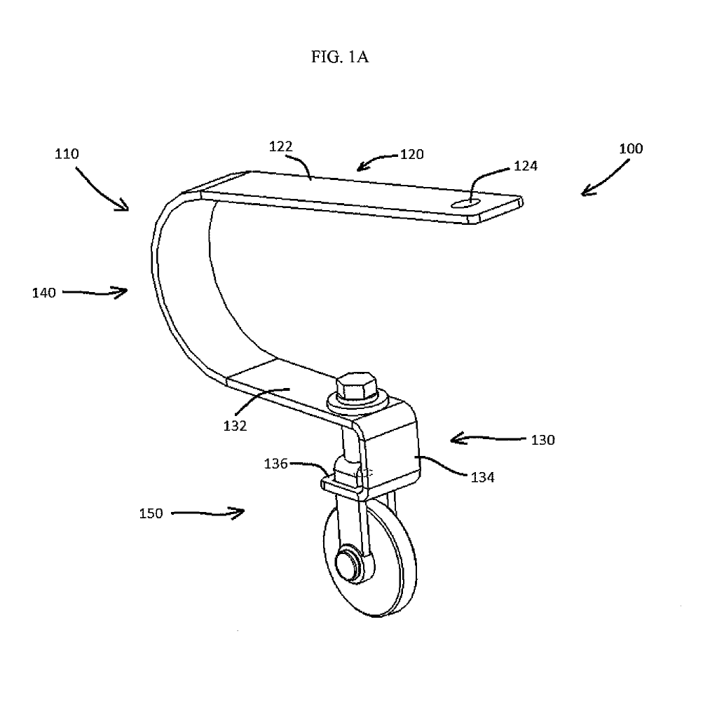

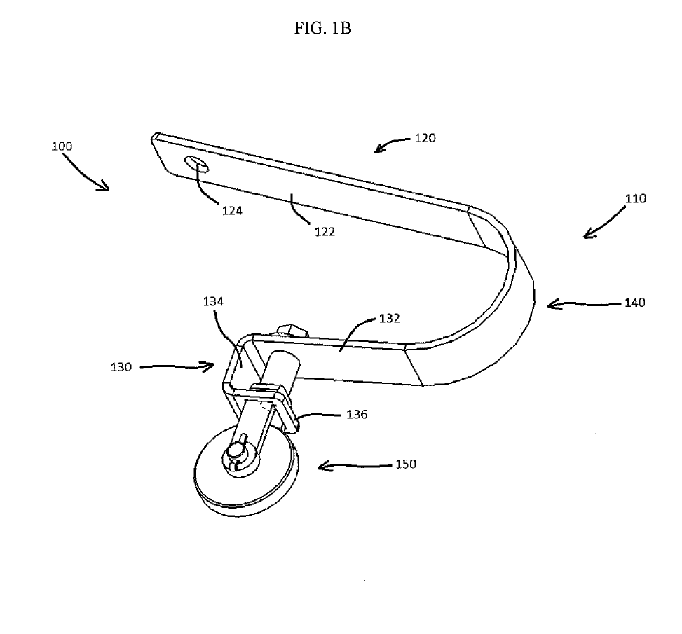

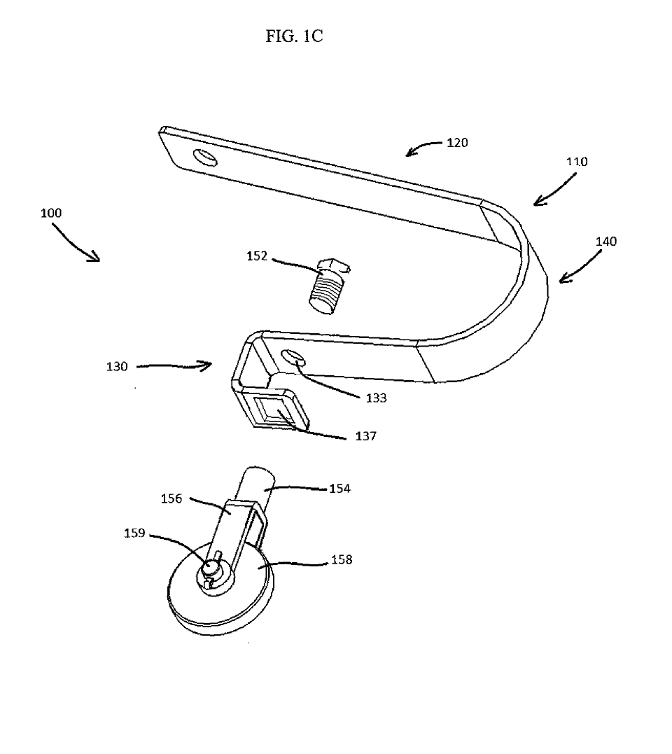

FIGS. 1A and 1B are views of a spring assembly 100 usable with example embodiments and FIG. 1C is an exploded view of the spring assembly 100 in accordance with example embodiments. As shown in FIGS. 1A, 1B, and 1C, the spring assembly 100 may include a spring 110 with a wheel assembly 150 attached thereto.

In example embodiments, the spring 110 may have a first interfacing region 120, a second interfacing region 130, and a connecting region 140 connecting the first interfacing region 120 to the second interfacing region 130. As shown in at least FIGS. 1A and 1B, the connecting region 140 may be curved to impart flexibility to the spring 110.

In example embodiments, the first interfacing region 120 may be comprised of a relatively flat member 122 having a hole 124 therein. The hole 124, while not necessary to the design, may allow the spring assembly 100 to attach to a structure via a screw type connection. Although the first interfacing region 120 may be flat (as shown in the figures), the first interfacing region 120 may have another shape such as, but not limited to, a curved shape, a stepped shape, or an undulating shape. Thus, the specific shape of the first interfacing region 120 of the spring 110 is not required to be flat as shown in the figures.

In example embodiments, the second interfacing region 130 may resemble a C-shaped section having a first portion 132, a second portion 134, and a third portion 136. Though not required, each of the first, second and third portions 132, 134, and 136 may be substantially flat, as shown in the figures. In another nonlimiting embodiment, the second portion 134 may be curved. Thus, the second interfacing region 130 may have a shape other than that shown in the figures. In example embodiments, the second interfacing region 130 may be configured to allow the wheel assembly 150 to attach to the spring 110.

As shown in FIG. 1C, the wheel assembly 150 may be comprised of a fastening member 152 having an externally threaded body, a body 154 having an internally threaded hole configured to engage the external threads of the fastening member 152, a fork 156 attached to the body 154, a wheel 158 supported by the fork 156, and a pin 159 connecting the wheel 158 to the fork 156. In example embodiments, each of the first and third portions 132 and 136 of the second interfacing region 130 may include an aperture configured to allow the wheel assembly 150 to attach thereto. For example, as shown in FIG. 1C, the first portion 132 may include a hole 133 and the third portion 136 may include an aperture 137. In example embodiments, the hole 133 may be sized to allow the body of the fastening member 152, for example, a threaded portion of a screw, to pass therethrough to connect to the body 154. The fork 156 may be configured to pass through the aperture 137 as shown in at least FIGS. 1A-1C. Though not shown in FIG. 1C, it is understood that various other components, such as washers and nuts, may additionally be used to help secure the wheel assembly 150 to the second interfacing region 130.

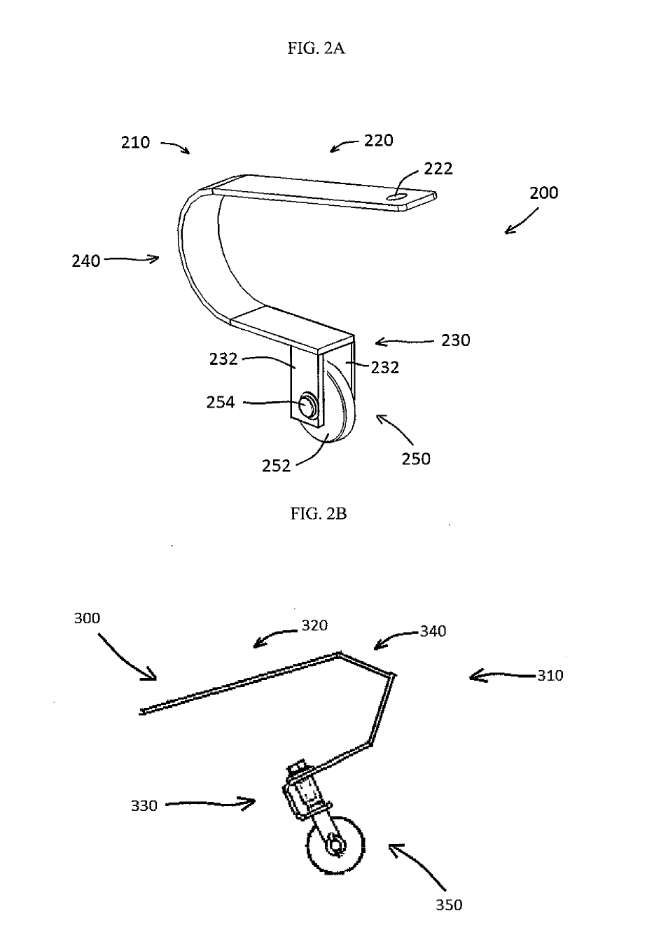

FIG. 2A is another example of a spring assembly 200 usable with example embodiments. As shown in FIG. 2A, the spring assembly 200 may include a spring 210 and a wheel assembly 250. In example embodiments, the spring 210 may have a first interfacing region 220, a second interfacing region 230, and a connecting region 240 connecting the first interfacing region 220 to the second interfacing region 230. Though not necessary, the first interfacing region 220 may include a hole 222 which may allow the first interfacing region 220 to connect to a structure using conventional structures such as, but not limited to, screws. The second interfacing region 230 may include a pair of plates 232 which may be used to support the wheel assembly 250. In example embodiments, the wheel assembly 250 may include a wheel 252 and an axel 254 supported by the pair of plates 232.

FIG. 2B illustrates another example of a spring assembly 300 in accordance with example embodiments. As shown in FIG. 2B, the spring assembly 300 may include a spring 310 and a wheel assembly 350. In example embodiments, the spring 310 may include a first interfacing region 320, a second interfacing region 330, and a connecting region 340 connecting the first interfacing region 320 to the second interfacing region 330. In example embodiments, the spring assembly 300 may be substantially identical to the spring assembly 100 except that, rather than having a curved connecting region 140, the first interfacing region 320 is connected to the second interfacing region 330 by a V-shaped connecting region 340. In example embodiments, the wheel assembly 350 may be substantially identical to the wheel assembly 150, therefore, a description thereof is omitted for the sake of brevity.

In example embodiments, the springs 110, 210, and 310 may be fabricated from a bar, for example a metal bar, wherein the bends in the bar are formed by conventional bending operations. As, such, cross-sections of the spring members 110, 210, and 310 may be, but are not required to be, substantially rectangular. Example embodiments, however, are not limited thereto as the spring members 110, 210, and 310 may be made from a casting process wherein the casted spring does not have a rectangular cross-section. In the alternative, the spring members 110, 210, and 310 may be made from a material other than metal. For example, in example embodiments, the spring members 110, 210, and 310 may be made from a composite material and, therefore, may have a variable cross-section.

It is understood that the aforementioned examples of a spring assembly 100, 200, and 300 are for purposes of illustration only and for providing examples of spring assemblies usable with example embodiments. These specific examples, however, are not intended to limit the invention as variations of the example spring assemblies 100, 200, and 300 are considered to fall within the inventive concepts of this application.

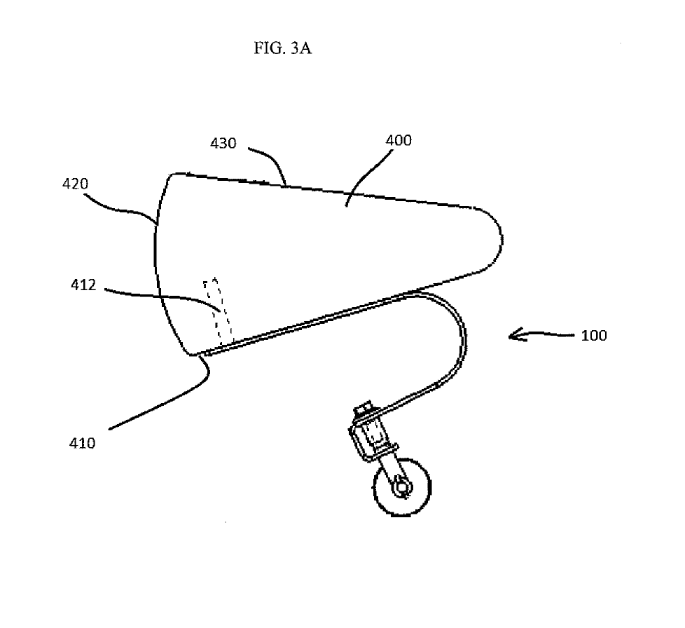

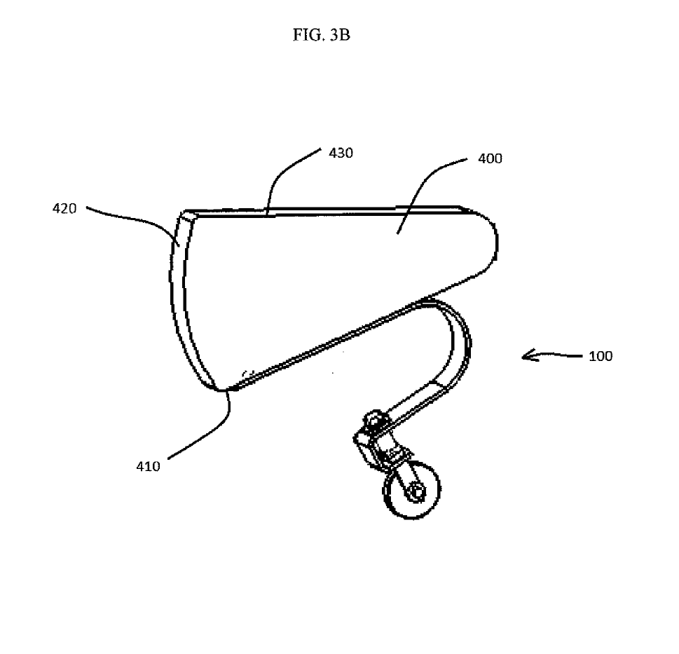

FIG. 3A is a view of the spring assembly 100 attached to a latch arm 400 and FIG. 3B is a perspective view of the spring assembly 100 attached to the latch arm 400. In example embodiments, the latch arm 400 may be fabricated from a metal plate and thus, may have a substantially constant thickness as shown in FIG. 3B. Example embodiments, however, are not limited by this feature as the thickness of the latch arm 400 may vary.

In example embodiments, the latch arm 400 may have a first surface 410 which may be substantially complementary to the first interfacing region 120 of the spring assembly 100. For example, as shown in the figures, the first surface 410 and the first interfacing region 120 may each be substantially flat. In example embodiments, the first surface 410, for example, may have a threaded hole 412 which may be configured to receive a faster, such as a screw. Thus, in example embodiments, the spring assembly 100 may be fastened to the latch arm 400 by passing a screw through the hole 124 of the first interfacing region 120 of the spring assembly 100 and into the threaded hole 412 of the latch arm 400. This, however, is only an example of how the spring assembly 100 may be attached to the latch arm 400 and is not intended to limit the invention. For example, in example embodiments, rather than using a screw to attach the spring assembly 100 to the latch arm 400, the spring assembly 100 may be attached to the latch arm 400 by welding, pinning, gluing, and or by using clips. Also, in example embodiments, it is understood that the other nonlimiting examples of spring assemblies 200 and 300 may attached to the latch arm 400 in lieu of the spring assembly 100.

In example embodiments, the latch arm 400 may include a second surface 420 and a third surface 430. In example embodiments, the second surface 420 may be, but is not required to be, a substantially curved surface and the third surface 430 may be, but is not required to be, a substantially flat surface. In some applications, a curved second surface 420 and a flat third surface 430 may be advantageous depending on how the latch arm 400 is implemented in a latching system.

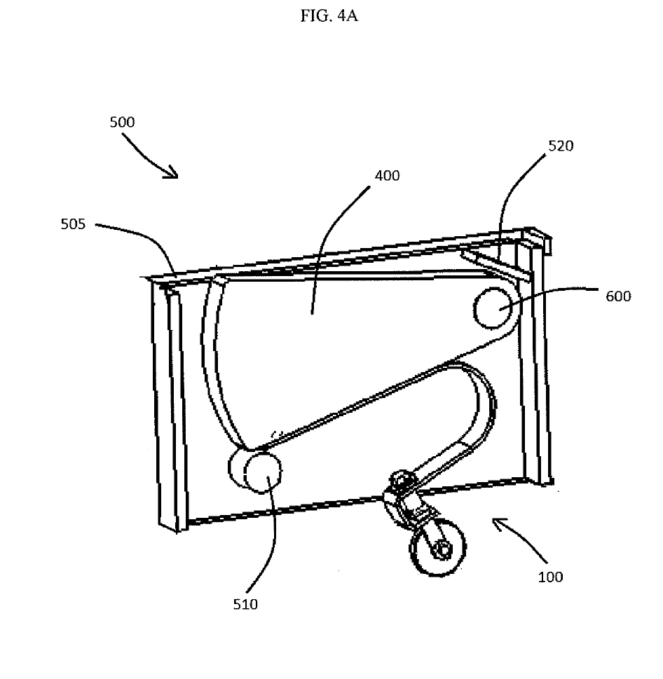

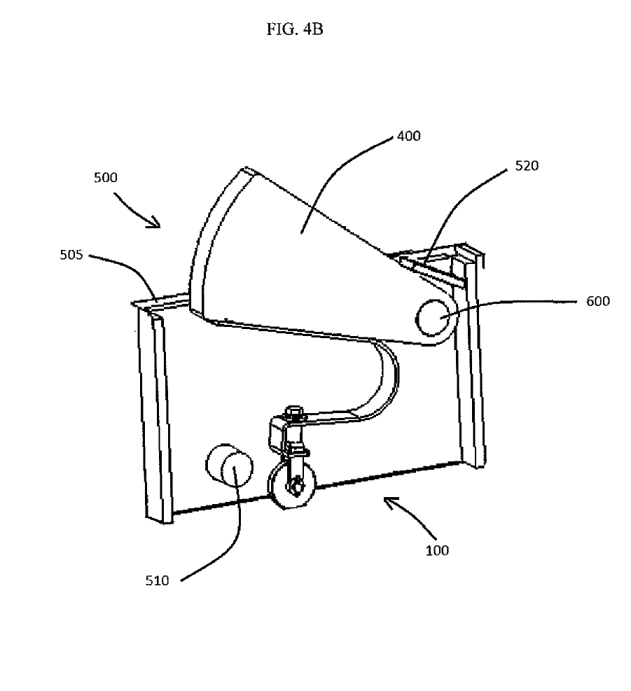

FIGS. 4A and 4B illustrate a structure 500 to which the latch arm 400 and the spring assembly 100 is attached. In example embodiments the latch arm 400 may be pivotally attached to the structure 500. For example, as shown in FIGS. 4A and 4B, a pin 600 may be used to pivotally attach the latch arm 400 to the structure 500. Use of a pin 600, however, is not intended to be a limiting feature of example embodiments and the latch arm 400 may be pivotally secured to the structure 500 by a variety of ways including, but not limited to, using screws, clamps, and protrusions.

In example embodiments, the structure 500 may include a first stop 510 and a second stop 520 to restrain a motion of the latch arm 400. For example, the first and second stops 510 and 520 may restrain the latch arm 400 from rotating beyond pre-set points. Between the first and second stops 510 and 520, however, the latch arm 400 is free to rotate. For example, as shown in FIG. 4A, the latch arm 400 may be rotated counterclockwise until it contacts the first stop 510. In this position, the latch arm 400 may be entirely, or mostly, below an upper 505 of the structure 500. As another example, as shown in FIG. 4B, the latch arm 400 may be rotated clockwise until it contacts the second stop 520. In this position, the second surface 420 of latch arm 400 may be exposed above the upper surface 505 of the structure 500. While the presence of the first and second stops 510 and 520 may be desirable in some applications, it is understood that one of, or both of, the stops 510 and 520 may be omitted from a latching system in accordance with example embodiments.

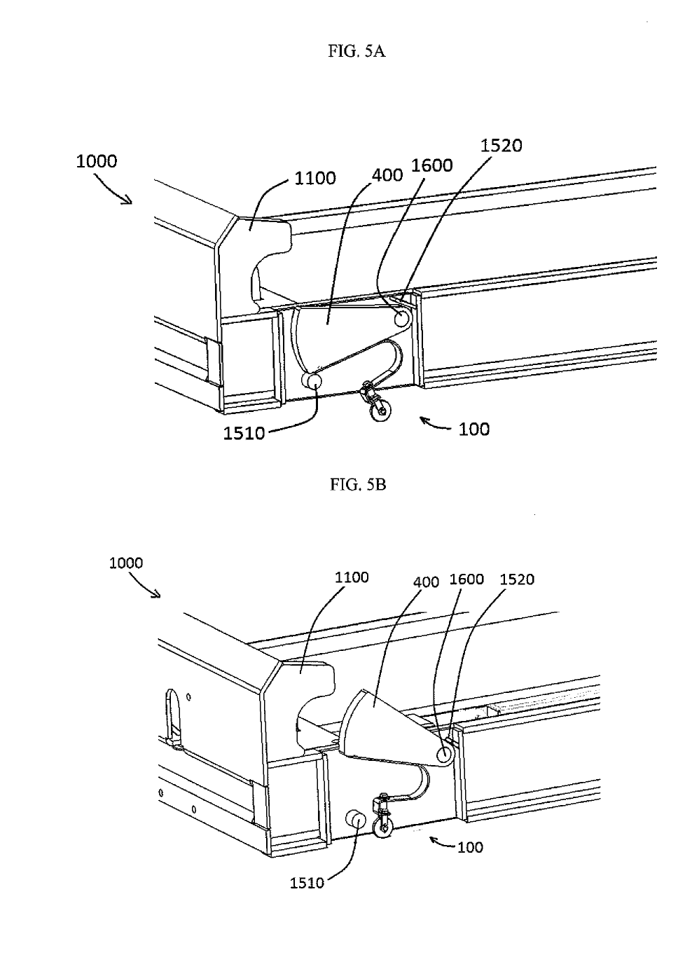

FIGS. 5A and 5B are partial views of a tilt frame 1000 (an example of a primary support member) in accordance with example embodiments. The tilt frame 1000 may be, but is not required to be, part of a roll-on truck and may be configured to accommodate a container that may be rolled thereon. In example embodiments, the tilt frame 1000 may include a latching system in accordance with example embodiments. In this particular nonlimiting example, the tilt frame 1000 may include the latch arm 400 pivotally mounted to the tilt frame 1000 by a pin 1600. In example embodiments, the latch arm 400 may have the spring assembly 100 mounted thereto as was previously described. In example embodiments, the tilt frame 1000 may further include a first stop 1510 and a second stop 1520 to restrain the rotation of the latch arm 400. In addition, the tilt frame 1000 may further include a catch 1100 which may be configured to catch a member of the container that may travel along the surface of the tilt frame 1000. As shown in FIGS. 5A and 5B, the latch arm 400 may rotate between the first and second stops 1510 and 1520.

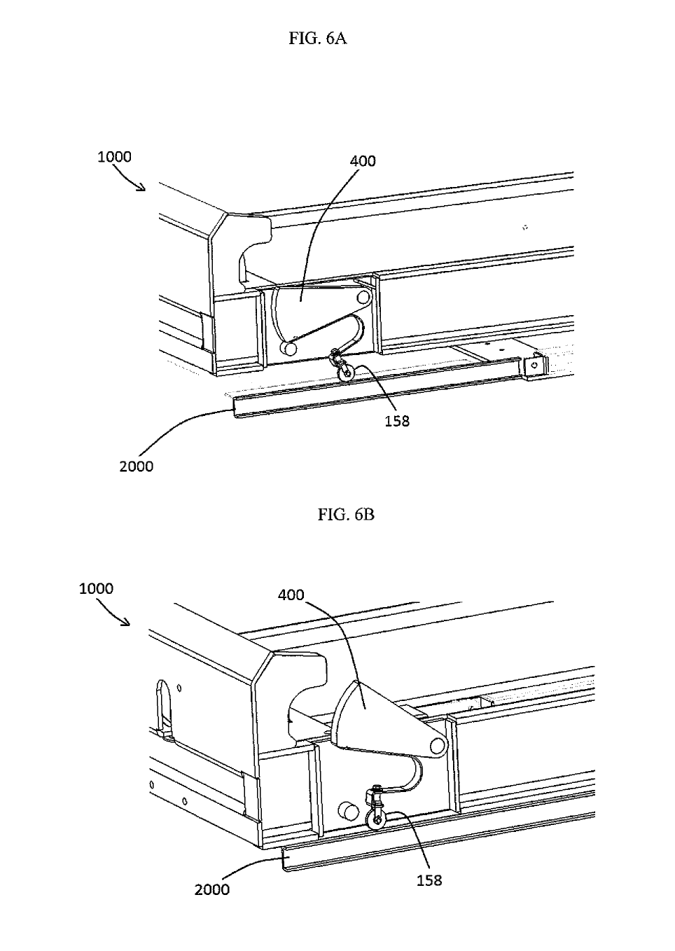

FIGS. 6A and 6B are substantially the same as FIGS. 5A and 5B except that FIGS. 6A and 6B present an interfacing member 2000 that may be configured to interface with the wheel 158 of the spring assembly 100. In example embodiments, the interfacing member 2000 may be part of a chassis of the roll-on truck or may be an additional member added to the chassis of the roll-on truck in order to provide a force on the wheel 158. For example, in example embodiments the tilt frame 1000 may be rotated onto the interfacing member 2000 so that the wheel 158 presses against the interfacing member 2000. As the tilt frame 1000 is further rotated, the interfacing member 2000 provides a reactive force against the wheel 158 which in turn causes the latch arm 400 to rotate clockwise to the position of FIG. 6B. In this position, at least a portion of the latch arm 400 extends beyond an upper surface of the tilt frame 1000.

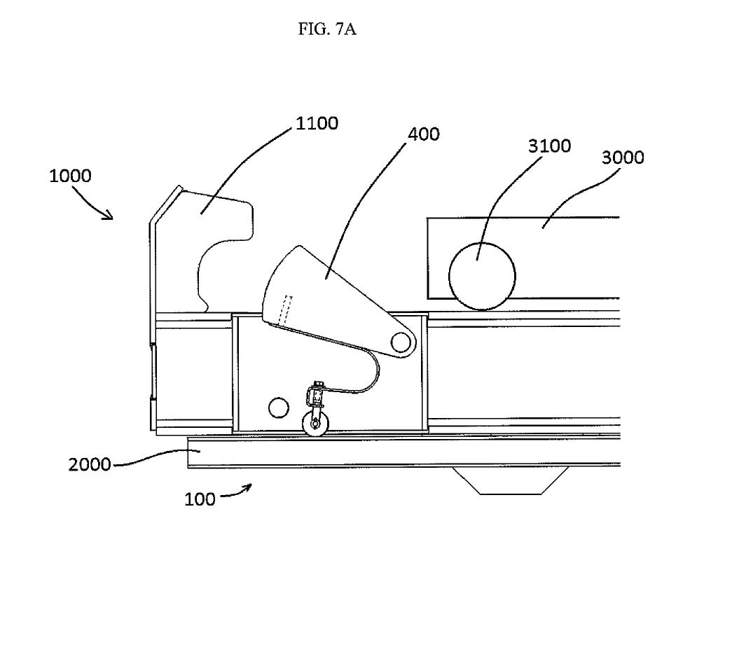

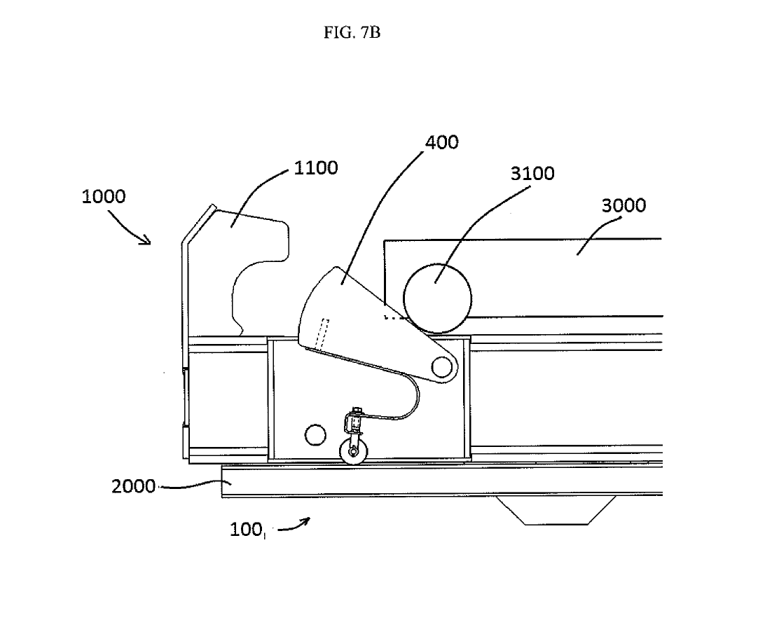

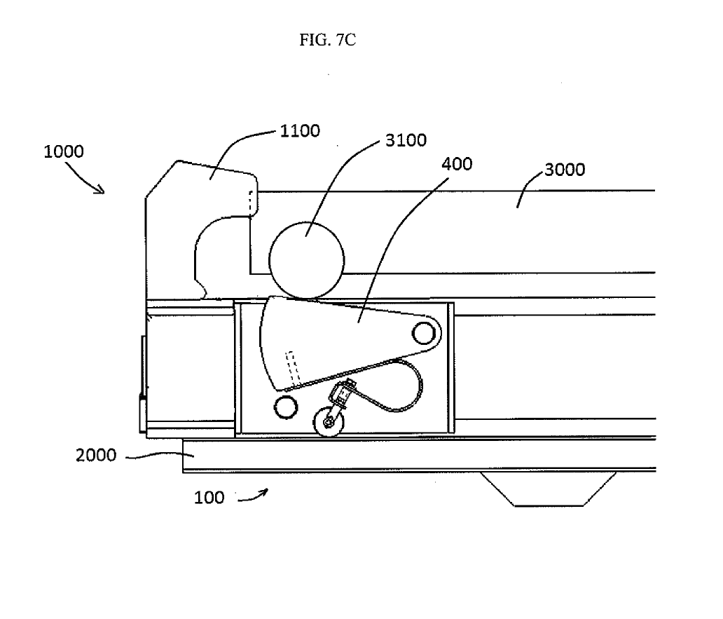

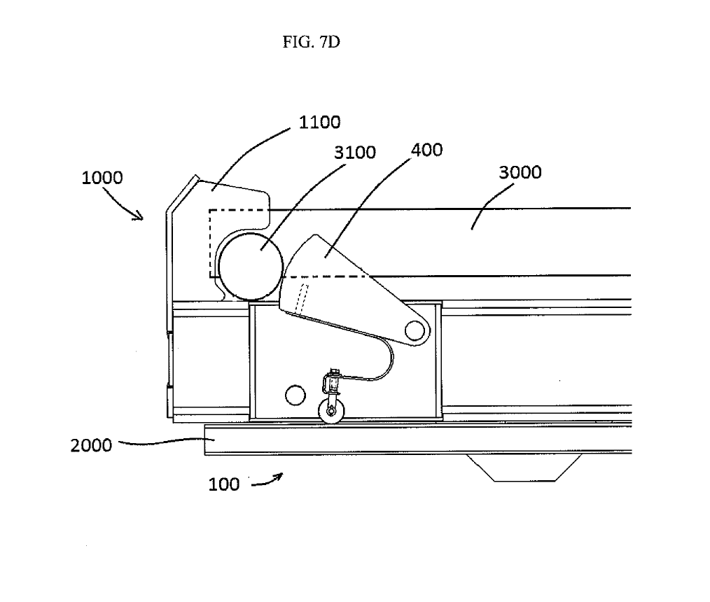

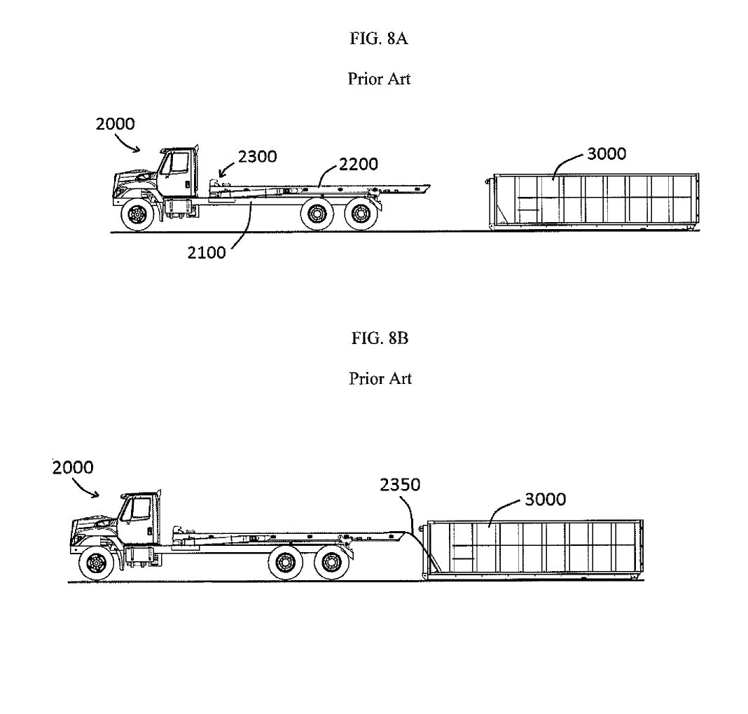

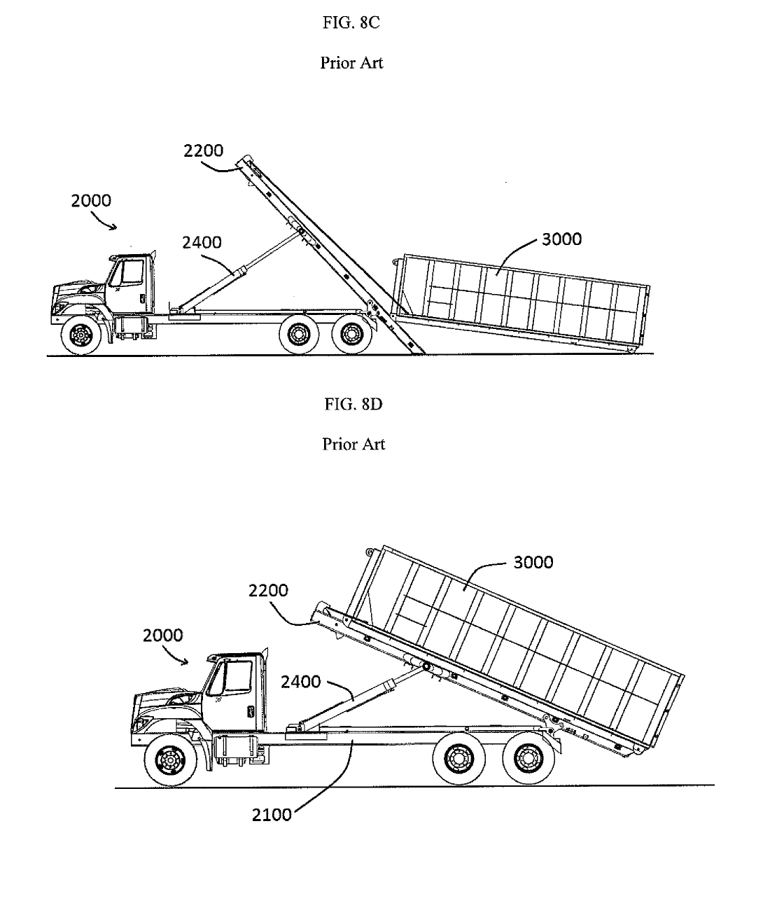

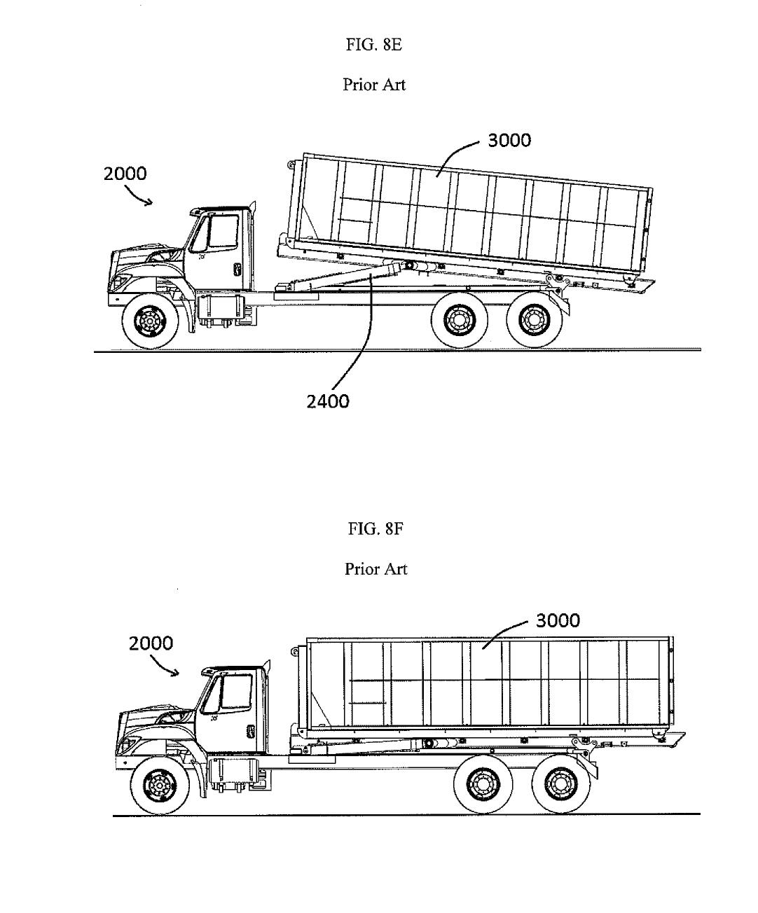

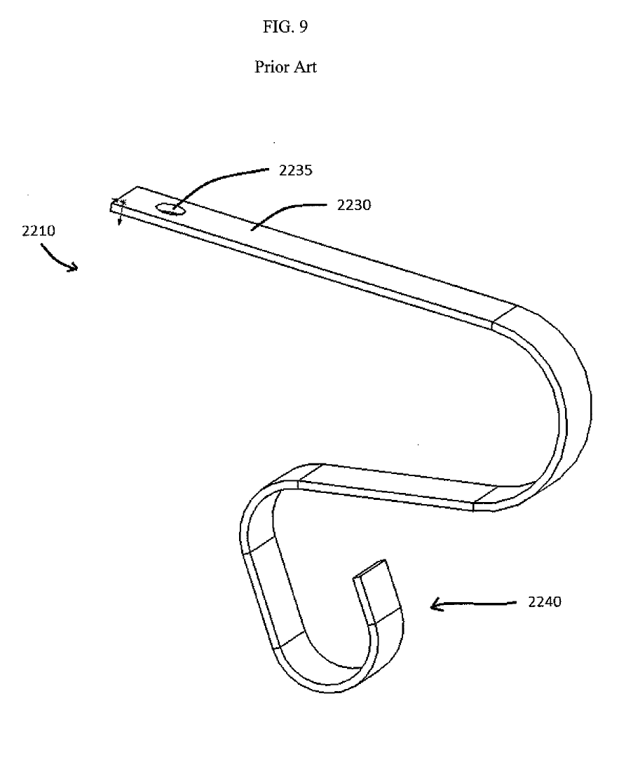

FIGS. 7A-7D illustrate a container 3000 being captured by the latch system in accordance with example embodiments. In FIGS. 7A-7D the tilt frame 1000 is rotated onto the interfacing member 2000 so that the latch arm 400 is rotated above an upper surface of the tilt frame 1000. Referring to FIG. 7A, the container 3000 may be arranged on the tilt frame 1000. Further, an actuator (not shown), for example, a winch or a reeving mechanism, may pull the container 3000 along a top of the tilt frame 1000 towards the catch 1100. In example embodiments, the container 3000 may include wheels or rollers 3100 to facilitate the movement of the container 3000 on the tilt frame 1000. As container 3000 advances towards the catch 1100 the rollers or wheels 3100 contact the latch arm 400, as shown in FIG. 7B. Further movement of the container 3000 causes the latch arm 400 to rotate downwards deforming the spring assembly 100 as shown in FIG. 7C. After the rollers 3000 pass over the latch arm 400, however, the spring assembly 100 biases the latch arm 400 back into its previous position as shown in FIG. 7D thus capturing the rollers or wheels 3100 between the catch 1100 and the latch arm 400. In the event it is desired to move the container 3000 back down the tilt frame 1000, an operator would simply rotate the tilt frame 1000 away from the interfacing member 2000 to rotate the latch arm 400 back into a position illustrated in FIG. 6A. In the rotated configuration, the container 3000 may be moved away from the catch 1100 and back down the tilt frame 1000.

In FIGS. 3A-7D the latch arm 400 was illustrated as being associated with the spring assembly 100. This is not intended to be a limiting feature of example embodiments since the latch arm 400 may be associated with different spring assemblies such as, but not limited to, the spring assemblies 200 and 300. Furthermore, example embodiments are not limited the particular examples illustrated herein. For example, although the latching system of example embodiments has been illustrated as being associated with a roll-on truck, example embodiments are not limited thereto as the invention is applicable to various structures and devices. Furthermore, although FIGS. 7A-7D illustrate a latching device configured to capture a wheel or a roller of a container, the invention is not limited thereto as the latching device may capture another member such as, but not limited to, a protrusion associated with a container or a structure other than a container.

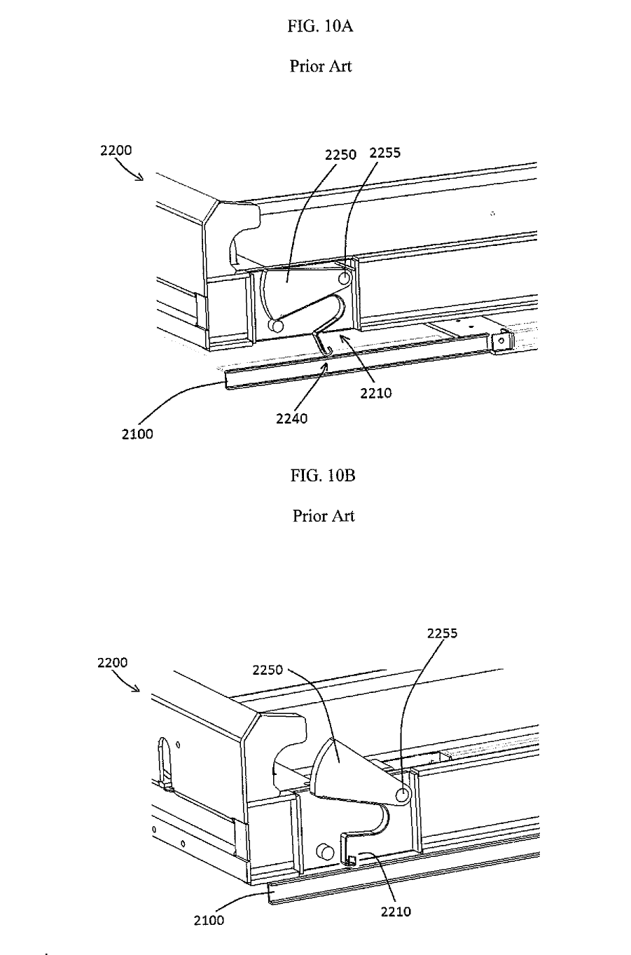

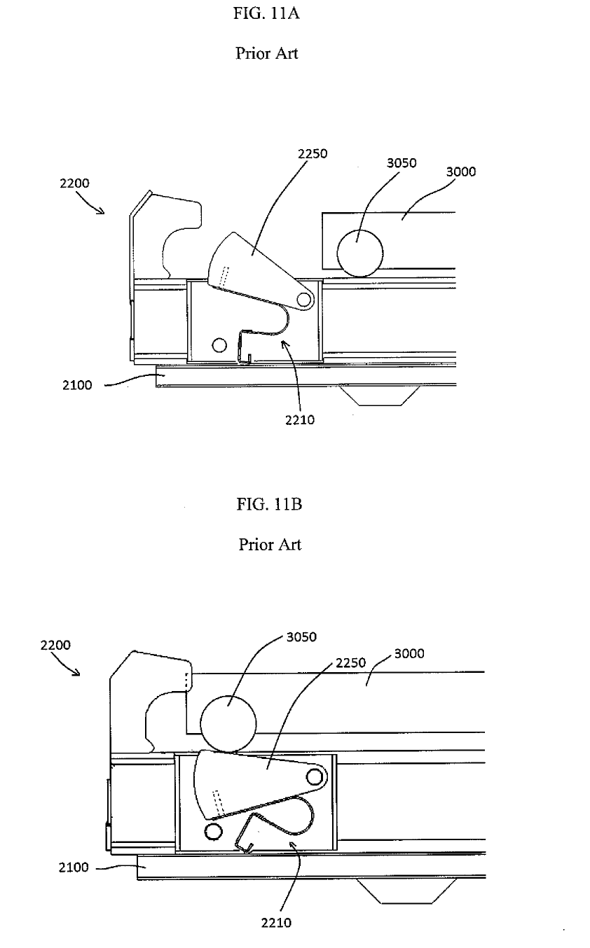

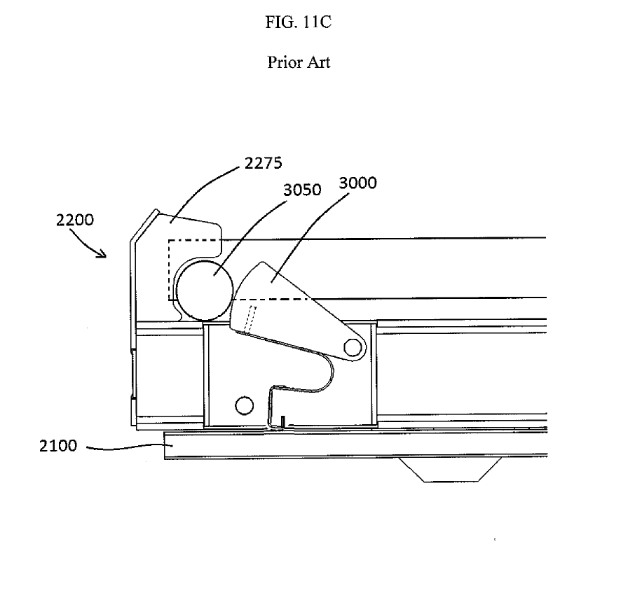

The latching device of example embodiments offers clear advantages over the prior art. For example, referring to FIGS. 10A-10B, when the curved second end 2240 of the conventional spring 2210 contacts the chassis 2100, static friction between the chassis 2100 and the curved second end 2240 may be generated. This friction may become relatively high and may actually cause damage to each of the chassis 2100 and the spring 2210. In addition, the movement of the conventional latch arm 2250 may experience a relatively significant acceleration as the static friction force between the chassis 2100 and the spring 2210 is overcome, thereby leading to a rather erratic motion that may affect a latch engagement between a roll on container and a tilt frame of a roll on truck. However, in example embodiments, because the spring assembly 100 includes a wheel 158 arranged at an end thereof, static friction between the spring assembly 100 and the interfacing member 2100 (which may be a part of a chassis of a roll on roll off truck) may be reduced, minimized, if not eliminated. Thus, the generation of static friction exerted on a chassis of a roll on roll off truck may be avoided thereby reducing damage to the roll on roll off truck and spring. In addition, because the generation of static friction associated with the latching system of example embodiments is relatively low, the movement of the latch arm 400, compared to the movement of the conventional latch arm 2250, is also less erratic leading to a smoother latch engagement between a container and a roll off frame.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A spring assembly comprised of:
a spring having a first interfacing region, a second interfacing region, and a connecting region between the first interfacing region and the second interfacing region, the connecting region providing resilience to the spring; and
a wheel assembly attached to the second interfacing region.

2. The spring of claim 1, wherein the wheel assembly is attached to the second interfacing region.

3. The spring of claim 2, wherein a cross-sectional area of the spring is substantially rectangular shaped.

4. A latch comprising:
the spring assembly of claim 1; and
a latch arm attached to the first interfacing region.

5. The latch of claim 4, wherein the latch arm includes a curved surface.

6. A structure comprised of:
a primary support member; and
the latch of claim 4, wherein the latch arm is pivotally attached to the primary support member.

7. The structure of claim 6, further comprising:
a first stop configured to prevent the latch arm from rotating beyond a first point.

8. The structure of claim 7, further comprising:
a second stop configured to prevent the latch from rotating beyond a second point.

9. A system comprising:
the structure of claim 6; and
an engaging member, wherein a wheel of the wheel assembly is configured to engage the engaging member.

10. The system of claim 9, wherein the primary support member is a pivotally mounted frame configured to rotate onto the engaging member.

11. The system of claim 10, wherein when the primary support member is rotated onto the engaging member the engaging member provides a force on the wheel which causes the latch arm to rotate so that a portion of the latch arm protrudes above an upper surface of the primary support member.

12. A system comprising:
a first frame pivotally mounted on a second frame;
a latch attached to the first frame, the latch including a latch arm pivotally connected to the first frame and a spring attached to the latch arm, the spring including a wheel configured to engage the second frame, wherein when the wheel is engaged with the second frame, at least a portion of the latch arm is rotated above an upper surface of the first frame and when the wheel is not engaged with the second frame the latch arm is below the upper surface of the first frame.

13. The system of claim 12, further comprising:
a container configured to move along the first frame, the container including an interfacing member configured to press against the latch arm when the wheel is engaged with the second frame.

14. The system of claim 13, wherein the first frame includes a catch member configured to catch the interfacing member and when the interfacing member is in the catch member and the wheel is contacting the second frame, the interfacing member is captured between the catch member and the latch arm.
